(19) United States
(12) Patent Application Publication
(10) Pub. No.: US 2010/0265208 A1
(43) Pub. Date: Oct. 21, 2010

(54) TOUCH SCREEN USING TACTILE SENSORS, METHOD FOR MANUFACTURING THE SAME, AND ALGORITHM IMPLEMENTING METHOD FOR THE SAME

(75) Inventors: Jong-ho Kim, Daejeon (KR); Hyun-joon Kwon, Seoul (KR); Yon-kyu Park, Daejeon (KR); Min-seok Kim, Daejeon (KR); Dae-im Kang, Daejeon (KR); Jae-hyuk Choi, Daejeon (KR)

Correspondence Address: CANTOR COLBURN, LLP, 20 Church Street, 22nd Floor, Hartford, CT, 06103, US

(73) Assignee: KOREA RESEARCH INSTITUTE OF STANDARDS AND SCIENCE, Daejeon (KR)

(21) Appl. No.: 12/739,301

(22) PCT Filed: Nov. 6, 2007
(86) PCT No.: PCT/KR2007/005579

§ 371 Date: Apr. 22, 2010

(30) Foreign Application Priority Data
Oct. 24, 2007 (KR) 10-2007-0107456

(51) Int. Cl. H01J 9/24; G06F 3/045

(52) U.S. Cl. 345/174; 445/24

(57) ABSTRACT

Disclosed are a touch screen using contact resistance type tactile sensors, which can adjust the density of an object to be displayed on a screen based on the variation of a contact position and a contact force and achieve a multi-touch recognizing function, a method for manufacturing the same, and an algorithm implementing method for the same. The touch screen using contact resistance type tactile sensors includes a lower display panel such as a liquid crystal display (LCD), a transparent upper substrate, and a plurality of contact resistance type tactile sensors arranged between the upper substrate and the lower panel along the edge of the screen. The touch screen senses a contact position and a contact force based on a contact resistance generated from the contact resistance type tactile sensors, and has a multi-touch recognizing function.

### BACKGROUND OF THE INVENTION

1. Field of the Invention

The present invention relates to a touch screen using tactile sensors and a method for manufacturing the same, and more particularly, to a laminar touch screen using contact resistance type tactile sensors, which can adjust the density of an object to be displayed on a screen based on a contact position and the variation of a contact force depending on the variation of a contact resistance sensed by the contact resistance type tactile sensors and achieve a multi-touch recognizing function, a method for manufacturing the same, and an algorithm implementing method for the same.

2. Description of the Related Art

Generally, appliances, such as a cellular phone, personal digital assistant (PDA), laptop computer, game machine, navigation, etc., include a data input device to select and input a desired function. Such a data input device is classified into a keypad type (including a keyboard) in which data is inputted as a user pushes corresponding keys with his/her fingers, etc., and a contact type (including a touch pad) in which data is inputted as a user slightly touches a pad surface with his/her fingers, etc.

Of the above described types, the contact type input device (i.e. the touch pad) is again classified, based on their data recognizing method, into an electrostatic-capacity type and a resistance type.

FIG. 13 illustrates a conventional electrostatic-capacity type input device. As shown, the conventional electrostatic-capacity type input device includes a substrate 110 made of a film, plastic, or glass, transparent electrodes 120 (ITO metal layers) deposited on both surfaces of the substrate 110, and an insulating layer 130 formed on an upper one of the transparent electrodes 120. If a user touches a point on the insulating layer 130 formed on the transparent electrode 120 with a pen or finger, signals informing X and Y positions of the touch point are applied to the transparent electrode 120, and consequently, an electrostatic capacity of the transparent electrode 120 is changed. By calculating the magnitude of the changed electrostatic capacity, the X and Y positions of the touch point can be detected.

On the other hand, FIG. 14 illustrates a conventional resistance type input device. As shown, the conventional resistance type input device includes an upper substrate 210 and a lower substrate 210′, which are made of a film, plastic or glass, transparent electrodes 220 and 220′ stacked, respectively, on a lower surface of the upper substrate 210 and an upper surface of the lower substrate 210′, and dot spacers 230 arranged between the transparent electrodes 220 and 220′ by an interval. If the upper substrate 210 is pushed by a finger or pen, an electric signal for detecting a pushed position is applied onto both the transparent electrodes 220 and 220′ with the dot spacers 230 interposed therebetween. More specifically, when the transparent electrode 220 comes into contact with the transparent electrode 220′ on the lower substrate 210′ as the upper substrate 210 is pushed downward, the lower transparent electrode 220′ can detect the electric signal. By calculating the magnitude of the detected electric signal, the position of the pushed position can be determined.

However, when using the conventional contact type input devices configured as described above in a mobile phone or other various monitors, the conventional input devices can sense positional information of only one touch point. Even if a user touches two or more points simultaneously, the conventional input devices cannot sense positional information of the multiple touch points.

To solve the above problem, recently, an electrostatic-capacity type touch screen has been developed to have a matrix shape as shown in FIG. 15, in order to sense positional information of two or more touch points at a time.

However, a unit sensor, included in the electrostatic-capacity type touch screen, senses only the change of an electrostatic-capacity signal caused by a touch action, and has no function of sensing the variation of a contact force. Therefore, the unit sensor is simply used as an ON/OFF switch depending on a touch action, and has a difficulty to input a variety of information. In other words, the conventional electrostatic-capacity type touch screen has a disadvantage in that a user cannot input specific information, for example, a desired line thickness, color reorganization, depth change of characters or figures.

Similarly, even in the case of a conventional resistance type touch screen, it has no function of sensing the variation of a contact force and multiple touch points, although it can sense positional information of a single touch point.

Further, in the case of both the contact resistance type and electrostatic-capacity type touch screens, although they use transparent electrodes made of, for example, ITO and CNT, these transparent electrodes cannot achieve the transmissivity of visible rays up to 100%, resulting in low screen resolution. Moreover, these two types of touch screens suffer from very expensive manufacturing costs in relation to a touch portion and sensing system thereof.

### SUMMARY OF THE INVENTION

Therefore, the present invention has been made in view of the above problems, and it is an object of the present invention to provide a touch screen using contact resistance type tactile sensors, which can sense the position of a contact point and the variation of a contact force applied to the contact point, thereby enabling adjustment of the density and thickness of inputted characters and figures and can achieve a multi-touch recognizing function and a high screen-resolution, and which can simultaneously measure a contact position and the magnitude of a contact force, i.e. force applied to a contact point via combination of signals obtained from each tactile sensor when a plurality of contact resistance type tactile sensors is arranged along the edge of the screen, thereby enabling the input of a variety of information, and a method for manufacturing the same.

It is another object of the present invention to provide a touch screen, which can achieve a multi-touch recognizing function by monitoring the distribution of a force sensed by contact resistance type tactile sensors based on the lapse of time and in particular, can achieve a reduction in thickness when components of each tactile sensor are directly mounted on substrates of the touch screen.

In accordance with an aspect of the present invention, the above and other objects can be accomplished by the provision of a laminar touch screen using contact resistance type tactile sensors including: upper and lower substrates; and a plurality of contact resistance type tactile sensors arranged between the upper and lower substrates along the edge of the substrates, to allow the touch screen to sense a contact position and a contact force based on a contact resistance generated from the contact resistance type tactile sensors while achieving a multi-touch recognizing function, wherein each of the contact resistance type tactile sensors includes: electrode patterns stacked, respectively, on surfaces of the upper and lower substrates facing each other; a spacer interposed between the upper and lower substrates to keep a distance between the upper and lower substrates; and two resistor patterns installed, respectively, on the electrode patterns and adapted to generate different contact resistances when they come into contact with each other.

In accordance with another aspect of the present invention, there is provided a method for manufacturing a touch screen using contact resistance type tactile sensors including: manufacturing a plurality of contact resistance type tactile sensors; and installing the plurality of contact resistance type tactile sensors between upper and lower substrates along the edge of the substrates, wherein the manufacture of the contact resistance type tactile sensors includes: depositing electrode patterns on surfaces of the upper and lower surfaces facing each other, respectively; forming resistor patterns, respectively, on surfaces of the electrode patterns formed on the upper and lower substrates; and interposing a spacer between the upper and lower substrates having the resistor patterns formed on the surfaces of the electrode patterns, and bonding the upper and lower substrates to each other, and wherein the installation of the contact resistance type tactile sensors between the upper and lower substrates includes: arranging the plurality of contact resistance type tactile sensors along the edge of the lower substrate by a predetermined interval, and covering the upper plate over the contact resistance type tactile sensors to keep the contact resistance type tactile sensors at fixed positions.

In accordance with a further aspect of the present invention, there is provided an algorithm implementing method for processing a touch input on a touch screen comprising a plurality of contact resistance type tactile sensors arranged between upper and lower substrates along the edge of the substrates, the touch screen sensing a contact position and a contact force based on a contact resistance generated from the contact resistance type tactile sensors, wherein the algorithm implementing method allows two or more contact positions to be sensed by tracking the distribution of forces acting on the respective contact resistance type tactile sensors, symmetrically arranged about a reference point, based on the lapse of time, wherein the algorithm implementing method includes inputting touch information related to a repulsive force Σ\vec{F}ᵢ of the total force acting on the respective tactile sensors about a reference point, and a position \vec{R}ₜ of a contact point and the magnitude \vec{F}ₜ of a contact force applied to the contact point based on the moment Q\vec{M}ᵢ of the total force at the reference point, and wherein the magnitude \vec{F}ₜ of force applied to the contact point is equal to the repulsive force Σ\vec{F}ᵢ of the total force, the position \vec{R}ₜ of the contact point is calculated by dividing the moment Q\vec{M}ᵢ of the total force by the magnitude \vec{F}ₜ of force applied to the contact point, and the moment Q\vec{M}ᵢ of the total force is calculated from the sum of repulsive forces between the reference point and the respective contact resistance type tactile sensors.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual view illustrating a touch screen using contact resistance type tactile sensors according to the present invention;

FIG. 2 is a perspective view illustrating an embodiment of the touch screen using contact resistance type tactile sensors according to the present invention;

FIG. 3 is a side sectional view of the touch screen using the contact resistance type tactile sensors shown in FIG. 2;

FIGS. 4 to 8 are sectional views illustrating a method for manufacturing a contact resistance type tactile sensor constituting the touch screen according to another embodiment of the present invention;

FIG. 9 is a graph illustrating an algorithm implementing method for processing a touch input on the touch screen using contact resistance type tactile sensors according to the present invention;

FIG. 10 is a graph illustrating an algorithm implementing method for recognizing multiple touches in a y-axis direction based on the distribution of a force on the touch screen using contact resistance type tactile sensors according to the present invention;

FIG. 11 is a graph illustrating an algorithm implementing method for recognizing multiple touches in a x-axis direction based on the distribution of a force on the touch screen using contact resistance type tactile sensors according to the present invention;

FIG. 12 is a photograph of the touch screen using contact resistance type tactile sensors having a 2×10 array according to the present invention; and

FIGS. 13 to 15 are views illustrating different conventional touch screens.

### DETAILED DESCRIPTION OF THE PREFERRED EMBODIMENTS

Now, preferred embodiments of the present invention will be described in detail with reference to the annexed drawings. The following description related to the preferred embodiments will be written in detail to allow those skilled in the art to easily understand and realize the present invention.

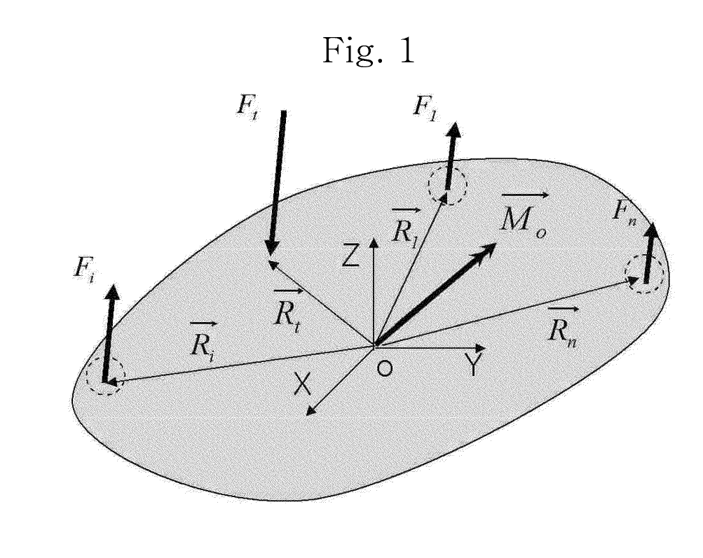

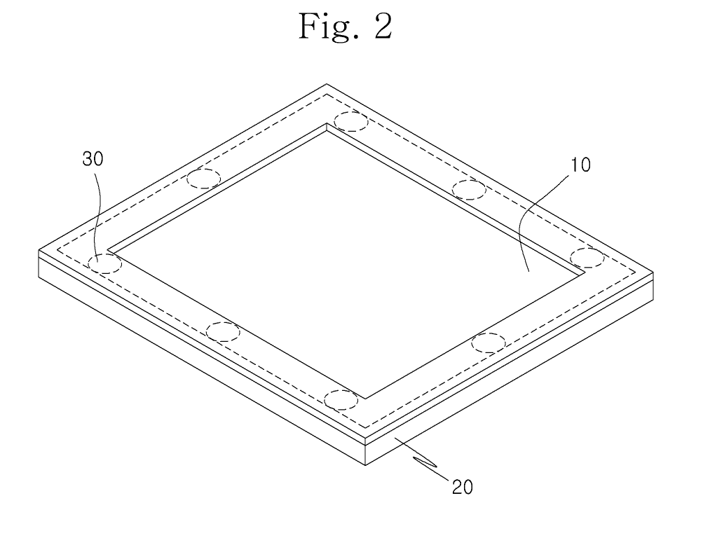

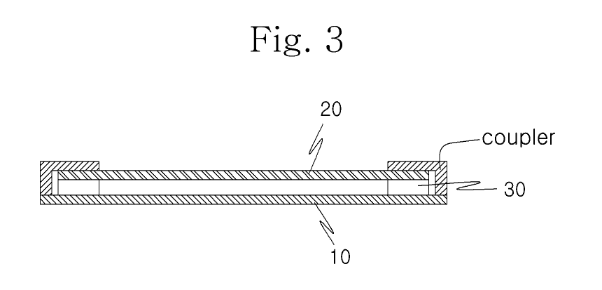

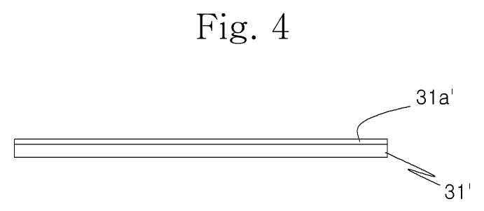

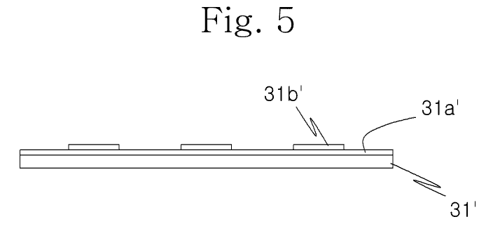

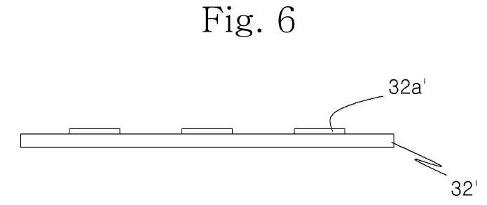

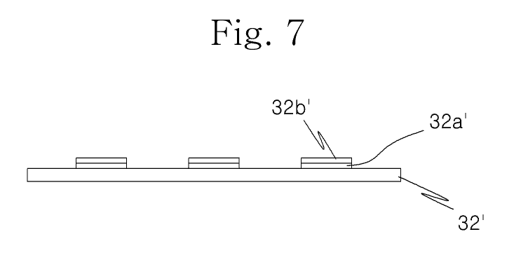

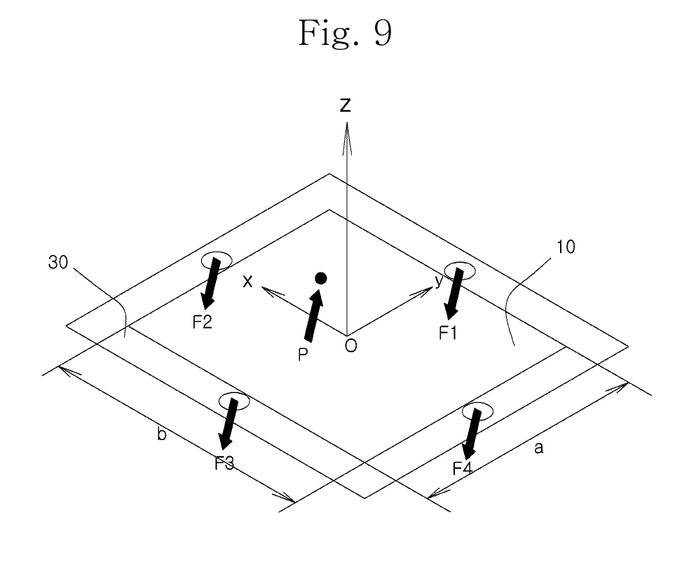

FIG. 1 is a conceptual view illustrating a touch screen using contact resistance type tactile sensors according to the present invention. FIG. 2 is a perspective view illustrating an embodiment of the touch screen using contact resistance type tactile sensors according to the present invention, and FIG. 3 is a side sectional view of the touch screen using the contact resistance type tactile sensors shown in FIG. 2, and FIGS. 4 to 8 are sectional views illustrating a method for manufacturing a contact resistance type tactile sensor constituting the touch screen according to another embodiment of the present invention. Also, FIG. 9 is a graph illustrating an algorithm implementing method for processing a touch input on the touch screen using contact resistance type tactile sensors according to the present invention.

As shown in the above drawings, the touch screen using contact resistance type tactile sensors according to the present invention has a feature in that contact resistance type tactile sensors 30 are arranged along the edge of the screen, to detect the position of a contact point and a contact force applied to the contact point, based on a distance from the contact point to each contact resistance type tactile sensor 30 and a repulsive force of each contact resistance type tactile sensor 30 against the contact force.

As shown in FIG. 1, when the contact resistance type tactile sensors are distributed along the edge of a transparent structure (upper panel), an algorithm implementing method for discriminating a contact point on the touch screen is as follows.

First, touch information is inputted. The touch information relates to a repulsive force Σ\vec{F}ᵢ of the total force acting on the respective contact resistance type tactile sensors 30 about a reference point O, and a position \vec{R}ₜ of the contact point and the magnitude \vec{F}ₜ of a force applied to the contact point based on the moment Q\vec{M}ᵢ of the total force at the reference point O.

The magnitude \vec{F}ₜ of the force applied to the contact point is equal to the repulsive force Σ\vec{F}ᵢ of the total force, and the position \vec{R}ₜ of the contact point is calculated by dividing the moment ΣQ\vec{M}ᵢ of the total force by the magnitude \vec{F}ₜ of the force applied to the contact point. The moment Q\vec{M}ᵢ of the total force is calculated from the sum of repulsive forces between the reference point O and the respective contact resistance type tactile sensors 30.

The repulsive force Σ\vec{F}ᵢ of the total force is calculated by the following Equation.

Σ\vec{F}ᵢ=\vec{F}ₜ Equation

Also, the position \vec{R}ₜ of the contact point is calculated by the following Equation.

Q\vec{M}ᵢ=\vec{R}₁X\vec{F}₁+ . . . +\vec{R}ᵢX\vec{F}ᵢ+ . . . +\vec{R}ₙX\vec{F}ₙ=\vec{R}ₜX\vec{F}ₜ Equation

Hereinafter, the configuration of the touch screen using the contact resistance type tactile sensors according to the present invention will be described in detail.

Although the basic configuration of the touch screen according to the present invention is equal or similar to that of the conventional touch screen as described in the above Description of the Related Art, the touch screen of the present invention has an outstanding feature in that the contact resistance type tactile sensors 30 are arranged along the edge of the screen.

Specifically, in the touch screen according to the present invention, the plurality of contact resistance type tactile sensors 30 are arranged between transparent lower and upper substrates 10 and 20 along the edge of the screen such that a contact position and a contact force can be detected based on a contact resistance generated from the contact resistance type tactile sensors 30.

Preferably, the upper substrate 20 is formed of a transparent plastic or glass substrate. In an alternative embodiment, the upper substrate may be used in a conventional electrostatic-capacity type or contact-resistance type touch screen. In this case, the contact position can be detected by a conventional method, and the contact force and multiple touch points can be detected based on the distribution of the contact force.

The above described contact resistance type tactile sensors 30 are provided between the upper and lower substrates 20 and 10 such that they are arranged only along the edge of the upper and lower substrates 20 and 10 by a constant interval.

The tactile sensors 30 may be of a contact resistance type.

The tactile sensor 30 according to the present invention is a contact resistance type tactile sensor configured as shown in FIGS. 4 to 8.

The contact resistance type tactile sensor 30 comprises: two thin films 31′ and 32′; electrode patterns 31a′ and 32a′ stacked on surfaces of the films 31′ and 32′ facing each other; a spacer 33′ interposed between the films 31′ and 32′ to keep a distance between the films 31′ and 32′; and two resistor patterns 31b′ and 32b′ installed on the electrode patterns 31a′ and 32a′, respectively, and adapted to generate different contact resistances when they come into contact with each other.

The films 31′ and 32′ and the electrode patterns 31a′ and 32a′ constituting the contact resistance type tactile sensor 30 may be made of a polyimide film, polyester film, or the like. Alternatively, electrodes or resistors may be directly formed on the upper and lower substrates 20 and 10 without using the films 31′ and 32′.

Although the electrode patterns 31a′ and 32a′ may be made of any one of copper and gold as metals, or carbon nano-tubes (CNT), the electrode patterns 31a′ and 32a′ are preferably made of copper.

The spacer 33′ is a structure to keep a distance between the two films 31′ and 32′. The spacer 33′ is made of an insulating material.

The resistor patterns 31b′ and 32b′ are made of a nickel-chrome (Ni—Cr) or carbon layer and a pressure-sensitive ink.

Hereinafter, a method for manufacturing the touch screen having the above described configuration will be described.

First, the method for manufacturing the touch screen generally comprises: a process of manufacturing the contact resistance type tactile sensors 30; and a process of installing the plurality of contact resistance type tactile sensors 30 between the upper and lower substrates 20 and 10 along the edge of the screen.

Hereinafter, the manufacture of the contact resistance type tactile sensor 30 will be described in detail with reference to FIGS. 4 to 8.

The process of manufacturing the contact resistance type tactile sensors 30 comprises the steps of: forming the electrode pattern 31a′ on a surface of the thin film 31′ and the electrode pattern 32a′ on a surface of the thin film 32′ by deposition; interposing the spacer 33′ between the two films 31′ and 32′ formed with the electrode patterns 31a′ and 32a′ and bonding the two films 31′ and 32′ to each other.

The step of forming the electrode patterns 31a′ and 32a′ may be performed by sputtering deposition. Although the electrode patterns 31a′ and 32a′ may be made of any one of copper and gold as metals, or carbon nano-tubes (CNT), the electrode patterns 31a′ and 32a′ are preferably made of copper.

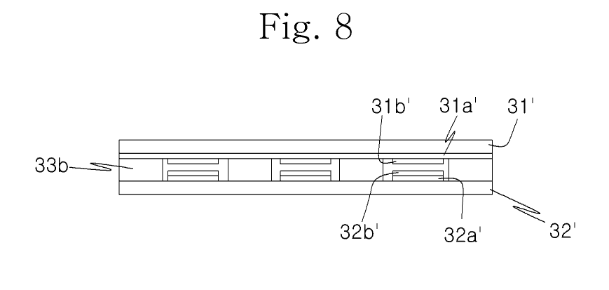

The electrode patterns 31a′ and 32a′ formed on the films 31′ and 32′, as shown in FIG. 8, are formed at surfaces of the respective films 31′ and 32′ facing each other, such that the two electrode patterns 31a′ and 32a′ are isolated from each other by the spacer 33′, so as not to come into contact with each other.

The resistor patterns 31b′ and 32b′ are formed on facing surface of the electrode patterns 31a′ and 32a′ formed on the films 31′ and 32′.

The electrode patterns 31a′ and 32a′ and the resistor patterns 31b′ and 32b′ are formed on facing surfaces of the two films 31′ and 32′, so that a distance between the two resistor patterns 31b′ and 32b′ can be changed upon deformation of the film 31′.

The manufactured contact resistance type tactile sensors 30 are installed between the upper and lower substrates 10 and 20 such that they are arranged along the edge of the two substrates 10 and 20.

It will be understood from the above description that, when the films 31′ and 32′ constituting the contact resistance type tactile sensor 30 are replaced by the upper and lower substrates 20 and 10, the electrode patterns 31a′ and 32a′ are directly formed on the two substrates 10 and 20.

As described above in brief, the touch screen having the above described configuration can sense the position of a contact point and a contact force applied to the contact point based on the distance from the contact point to each contact resistance type tactile sensor 30 and the repulsive force of each contact resistance type tactile sensor 30 against the contact force.

FIG. 9 is a graph illustrating an algorithm implementing method for processing a touch input on the touch screen using contact resistance type tactile sensors according to the present invention.

As shown, contact resistance type tactile sensors are installed at upper and lower, left and right positions, respectively, and a reference point O is located at the center of the four contact resistance type tactile sensors.

In a procedure of processing a touch input on the touch screen having the above described configuration, the repulsive force \vec{F}ₜ of the total force is represented by the following Equation.

\vec{F}ₜ=Σ\vec{F}ᵢ=−(F₁+F₂+F₃+F₄)\vec{k}=−P\vec{k} Equation

Also, the moment Q\vec{M}ᵢ of the total force at the reference point O is represented by the following Equation.

$$Q {\vec{M}}_{i} = ( {F}_{3} - {F}_{1} ) \frac{a}{2} \vec{j} + ( {F}_{2} - {F}_{4} ) \frac{b}{2} \vec{i} = xP \vec{j} + yP \vec{i} \qquad Equation$$

The position \vec{R}ₜ of action of the total repulsive force is represented by the following Equation.

\vec{R}ₜ=x\vec{i}+y\vec{j} Equation

Also, the magnitude P of the total force calculated from the above Equation is represented as follows:

P=F₁+F₂+F₃+F₄

From the above Equations, coordinates of the position of the action of the total repulsive force can be calculated.

That is, x-axis and y-axis coordinates of the position of action of the total repulsive force is represented as follows:

$$x = \frac{( {F}_{3} - {F}_{1} )}{{F}_{t}} \frac{a}{2} and y = \frac{( {F}_{2} - {F}_{4} )}{{F}_{t}} \frac{b}{2}$$

As described above, based on information obtained from the plurality of contact resistance type tactile sensors arranged along the edge of the screen, the position of the contact point and the magnitude of the contact force applied to the contact point can be calculated. With the use of these information, for example, the density, thickness, etc. of characters or figures to be displayed on the screen can be adjusted.

Hereinafter, a multi-touch recognizing function of the touch screen according to the present invention will be described.

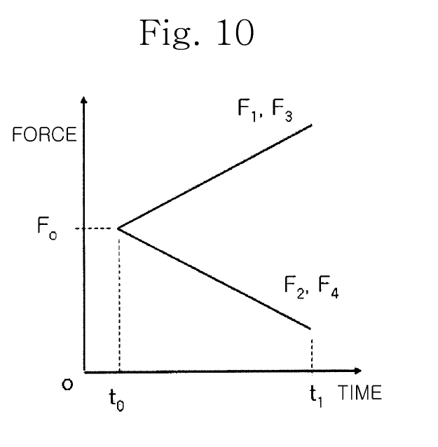

Referring first to FIG. 10, when two fingers touch the center O of the screen at a time tₒ, the four contact resistance type tactile sensors sense approximately the same force value Fₒ. However, as the two fingers are moved in +y-axis and −y-axis directions, the forces values F₁ and F₃ increase and the force values F₂ and F₄ decrease at a time t₁. Accordingly, by tracking the distribution of the forces sensed by the four sensors about the center of the touch screen based on the lapse of time, it is possible to sense multiple touch points in a y-axis direction.

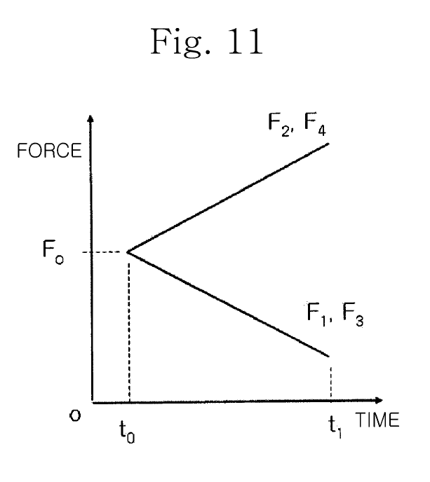

Referring to FIG. 11, when two fingers touch the center O of the screen at a time tₒ, the four contact resistance type tactile sensors sense approximately the same force value Fₒ. However, as the two fingers are moved in +x-axis and −x-axis directions, the forces values F₁ and F₃ decrease and the force values F₂ and F₄ increase at a time t₁. Accordingly, by tracking the distribution of the forces sensed by the four sensors about the center of the touch screen based on the lapse of time, it is possible to sense multiple touch points in a x-axis direction.

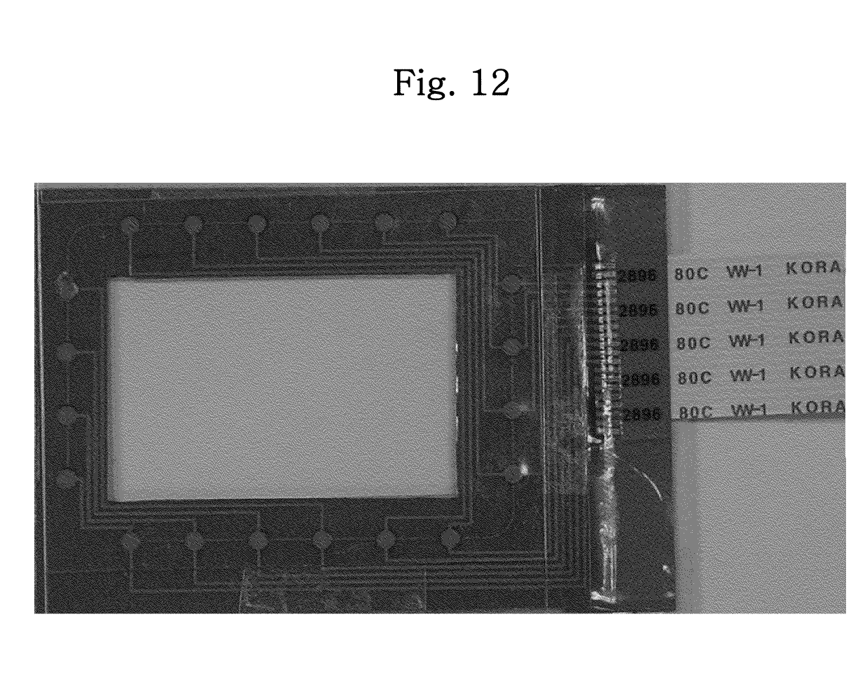

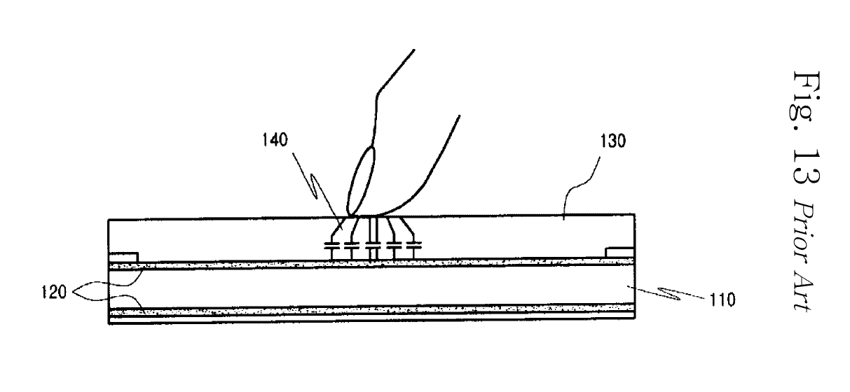

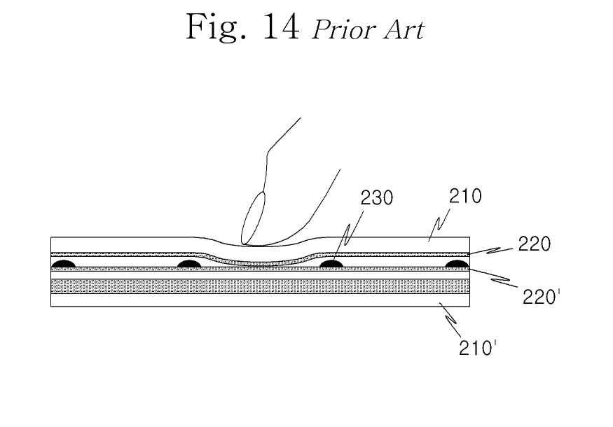

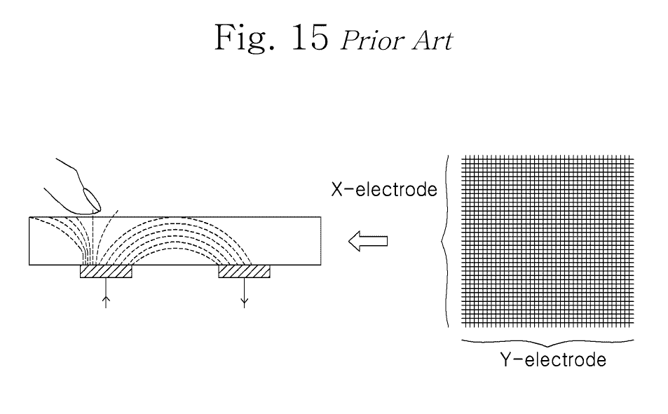

FIG. 12 is a photograph of the touch screen using contact resistance type tactile sensors having a 2×10 array according to the present invention.

As described above, a signal sensed according to the type of the contact resistance type tactile sensor is a resistance. The technology related to the sensing of such signals is equal or similar to the signal sensing method of a conventional contact sensor, and a detailed description thereof will be omitted.

As apparent from the above description, the present invention provides a touch screen in which a plurality of contact resistance type tactile sensors are arranged along the edge of the screen, to measure a contact force as well as a contact position by combining signals obtained from the respective contact resistance type tactile sensors. This has the effect of enabling the input of a variety of information. Moreover, with provision of the contact resistance type tactile sensors, a contact position and contact force can be sensed based on the variation of a contact resistance, resulting in enhanced contact sensing accuracy.

Further, according to the present invention, by monitoring the distribution of forces sensed by the contact resistance type tactile sensors based on the lapse of time, a multi-touch recognizing function can be accomplished.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A laminar touch screen using contact resistance type tactile sensors comprising:
upper and lower substrates; and
a plurality of contact resistance type tactile sensors arranged between the upper and lower substrates along the edge of the substrates, to allow the touch screen to sense a contact position and a contact force based on a contact resistance generated from the contact resistance type tactile sensors while achieving a multi-touch recognizing function,
wherein the contact resistance type tactile sensors sense the variation of a contact resistance according to a contact force, and
wherein each of the contact resistance type tactile sensors comprises: electrode patterns stacked, respectively, on surfaces of the upper and lower substrates facing each other; a spacer interposed between the upper and lower substrates to keep a distance between the upper and lower substrates; and two resistor patterns installed, respectively, on the electrode patterns and adapted to generate different contact resistances when they come into contact with each other.

2. (canceled)

3. (canceled)

4. (canceled)

5. (canceled)

6. (canceled)

7. (canceled)

8. (canceled)

9. (canceled)

10. A method for manufacturing a laminar touch screen using contact resistance type tactile sensors comprising:
manufacturing a plurality of contact resistance type tactile sensors; and
installing the plurality of contact resistance type tactile sensors between upper and lower substrates along the edge of the substrates, resistance values of which are changed according to a contact force,
wherein the manufacture of the contact resistance type tactile sensors comprises:
depositing electrode patterns on surfaces of the upper and lower surfaces facing each other, respectively;
forming resistor patterns, respectively, on surfaces of the electrode patterns formed on the upper and lower substrates; and
interposing a spacer between the upper and lower substrates having the resistor patterns formed on the surfaces of the electrode patterns, and bonding the upper and lower substrates to each other.

11. (canceled)

12. An algorithm implementing method for a laminar touch screen using contact resistance type tactile sensors to enable multi-touch recognition, a plurality of contact resistance type tactile sensors being arranged between upper and lower substrates along the edge of the substrates and being adapted to sense the variation of a contact resistance, each of the contact resistance type tactile sensors comprising: electrode patterns stacked, respectively, on surfaces of the upper and lower substrates facing each other; a spacer interposed between the upper and lower substrates to keep a distance between the upper and lower substrates; and two resistor patterns installed, respectively, on the electrode patterns and adapted to generate different contact resistances when they come into contact with each other, the algorithm implementing method processing a touch input on the touch screen using the contact resistance type tactile sensors adapted to sense a contact position and a contact force based on a contact resistance generated from the contact resistance type tactile sensors,
wherein the algorithm implementing method allows two or more contact positions to be sensed by tracking the distribution of forces acting on the respective contact resistance type tactile sensors, symmetrically arranged about a reference point, based on the lapse of time,
wherein the algorithm implementing method comprises inputting touch information related to a repulsive force Σ\vec{F}ᵢ of the total force acting on the respective contact resistance type tactile sensors, and a position \vec{R}ₜ of a contact point and the magnitude \vec{F}ₜ of force applied to the contact point based on the moment Q\vec{M}ᵢ of the total force at the reference point,
wherein the magnitude \vec{F}ₜ of force applied to the contact point is equal to the repulsive force Σ\vec{F}ᵢ of the total force, the position \vec{R}ₜ of the contact point is calculated by dividing the moment Q\vec{M}ᵢ of the total force by the magnitude \vec{F}ᵢ of force applied to the contact point, and the moment Q\vec{M}ᵢ of the total force is calculated from the sum of repulsive forces between the reference point and the respective contact resistance type tactile sensors,
wherein the repulsive force Σ\vec{F}ᵢ of the total force is represented as \vec{F}ₜ=Σ\vec{F}ᵢ=−(F₁+F₂+F₃+F₄)\vec{k}=−P\vec{k}, the moment Q\vec{M}ᵢ of the total force at the reference point is represented as
$$Q {\vec{M}}_{i} = ( {F}_{3} - {F}_{1} ) \frac{a}{2} \vec{j} + ( {F}_{2} - {F}_{4} ) \frac{b}{2} \vec{i} = xP \vec{j} + yP \vec{i} ,$$
the position \vec{R}ₜ of action of the total repulsive force is represented as \vec{R}ₜ=x\vec{i}+y\vec{j}, and the magnitude P of the total force is represented as P=F₁+F₂+F₃+F₄, and
wherein x-axis and y-axis coordinates of the position of action of the total repulsive force are represented as
$$x = \frac{( {F}_{3} - {F}_{1} )}{{F}_{t}} \frac{a}{2} and y = \frac{( {F}_{2} - {F}_{4} )}{{F}_{t}} \frac{b}{2} .$$

13. (canceled)

14. (canceled)
